(19) United States
(12) Patent Application Publication
(10) Pub. No.: US 2012/0010919 A1
(43) Pub. Date: Jan. 12, 2012

(54) NEW VISTAS IN INVENTORY OPTIMIZATION UNDER UNCERTAINTY

(76) Inventors: Abhilasha Aswal, Bangalore (IN); Gorur Narayana Srinivasa Prasanna, Bangalore (IN)

(21) Appl. No.: 13/255,408

(22) PCT Filed: Mar. 9, 2010
(86) PCT No.: PCT/IN10/00136

§ 371 Date: Sep. 8, 2011

(30) Foreign Application Priority Data
Mar. 9, 2009 (IN) 525/CHE/2009

(51) Int. Cl. G06Q 10/00; G06N 5/02

(52) U.S. Cl. 705/7.25; 706/52

(57) ABSTRACT

This invention relates to inventory optimization under uncertainty wherein uncertainty is represented in a constraint based framework derived from basic economic principles. This approach offers the ability to use information theoretic concepts to quantify the amount of information used in the optimization. The invention extends the state-of-art to include optimal inventory optimization when relevant supply chain variables are correlated. It can be used in other contexts also.

This invention relates to inventory optimization under uncertainty wherein uncertainty is represented in a constraint based framework derived from basic economic principles. This approach offers the ability to use information theoretic concepts to quantify the amount of information used in the optimization.

### I. INTRODUCTION

A major challenge in supply chain inventory optimization is handling uncertainty, as not all the data required for making decisions are available with certainty at the time of making the decision. This problem of design/analysis/optimization under uncertainty is central to decision support systems, and extensive research has been carried out in both Probabilistic (Stochastic) Optimization and Robust Optimization (constraints) frameworks. However, these techniques have not been widely adopted in practice, due to difficulties in conveniently estimating the data they require. Probability distributions of demand necessary for the stochastic optimization framework are generally not available. The constraint based approach of the Robust Optimization School has been limited in its ability to incorporate many criteria meaningful to supply chains. At best, the “price of robustness” of Bertsimas et al [4], [5] is able to incorporate symmetric variations around a nominal point. However, many real life supply chain constraints are not of this form.

The present approach modifies the robust optimization approach and makes it more intuitive and meaningful in the context of supply chains, while coupling optimization with information theory [12]. Uncertainty is represented in a constraint based framework naturally derived from basic economic principles [11]. The uncertainty sets (constraint sets) form a convex polytope, built from simple and intuitive linear constraints (simple sums and differences of supplies, demands etc) those are derivable from historical time series data. With this specification, many kinds of future uncertainty can be specified. This specification avoids deterministic but ad-hoc gravity models and their variants, as well as ad-hoc probability distributions. The optimization problems are computationally tractable—LP's or ILP's. Answers are globally valid over the entire range of parameter variations, which can be correlated.

In essence the present work is the first which enables design of supply chains using exactly the information most designers are comfortable with, without introducing any new assumptions, either in deterministic demand or probability distribution functions.

Not only this, the present approach offers the unique ability to quantify the amount of information used in the optimization based on information theoretic concepts. Finally, our approach is able to qualitatively compare different sets of uncertainty scenarios, using the relational algebra of polytopes.

Compared to earlier work, where the use of constraints [11] and static capacity planning [12] has been discussed, in the present invention, the aspects of inventory optimization have been discussed, and present algorithms for min-max policy optimization. Herein it has been discussed and illustrated as to how close-to-optimal heuristic techniques can be designed, and compare their performance relative to worst case bounds.

Hereinafter, the specification of uncertainty has been discussed followed by the presentation of algorithms for finding close to optimal solutions for the min-max optimizations and illustration of the ideas with a small but detailed example.

### II. RELATED WORK

For inventory optimization, the classical technique is the EOQ model proposed by Harris [9] in 1913. In the 1950's Arrow, Harris and Marschak [2], Dvoretzky, Kiefer and Wolfowitz, [8] and Whitin [13] began work on stochastic inventory control. In 1960, Clark and Scarf [7] proved the optimality of base stock policies using dynamic programming. These results minimally make some assumptions about the stochastics of the demand. The distribution independent robust optimization approach is typified by the work of Bertsimas, Sim and Thiele [4], [5] where they have proposed uncertainty models using robust optimization that also allow the level of conservatism to be controlled for each constraint. However their work is limited to symmetric polyhedral uncertainty sets with 2^{N} faces, and is not directly related to economically meaningful parameters. This symmetric nature does not distinguish between a positive and a negative deviation, which can be important in evaluating system dynamics (for example poles in the left versus right half plane).

### III. REPRESENTATION OF UNCERTAINTY

Compared to Bertsimas-Sim-Thiele, the present work is more expressive, with the ability to describe uncertainty sets described by arbitrary convex polytopes, e.g. with an arbitrary number of faces and orientations.

The polytopes are built from simple and intuitive linear constraints (simple sums and differences of supplies, demands etc) that are derivable from historical time series data. With this specification, many kinds of future uncertainty can be specified. Since the constraints are linear, most optimization problems (with linear metrics) can be modeled as linear, quadratic (in some cases) or integer linear programs. This specification avoids deterministic models using ad-hoc gravity models and their variants, as well as stochastic optimization based on ad-hoc probability distributions. This approach gives bounds on the performance parameters that are globally valid.

In the context of inventory optimization, the flexibility of our formulation allows us to describe absolute bounds on inventories, correlations between inventories and supplies/demands, correlations between inventories at different points, etc. Some examples of these constraints are:
i. Constraints on inventory: The total inventory at a node for a particular product at a particular time period may be limited,

Minᵢⱼₖ≦(Invᵢⱼₖ)≦Maxᵢⱼₖ;
∀iεnodes, jεproducts and kεt
   where Invᵢⱼₖ is the inventory at node i for product j in time period k.

The total inventory for a particular product at a particular node over all the time periods may be within limits,

$${Min}_{ij} \leq {\sum }_{k} ( {Inv}_{ijk} ) \leq {Max}_{ij} ;$$

$$∀ i ∈ nodes and j ∈ products$$

The total inventory for all the products at a particular node over all the time periods may be within limits,

$${Min}_{i} \leq {\sum }_{j} {\sum }_{k} ( {Inv}_{ijk} ) \leq {Max}_{i} ; ∀ i ∈ nodes$$

The total inventory for all the products at all the nodes that may ever be stored may be bounded,

$$Min \leq {\sum }_{i} {\sum }_{j} {\sum }_{k} ( {Inv}_{ijk} ) \leq Max$$

The total inventory for all the products at a particular node at a particular time period may be within bounds,

$${Min}_{ik} \leq {\sum }_{j} ( {Inv}_{ijk} ) \leq {Max}_{ik} ;$$

$$∀ i ∈ products and k ∈ t$$

$$Etc .$$

ii. Inventory tracking demand: The total inventory may be limited by total purchases. E.g., the total inventory for a particular product that can be stored over all the nodes, over all time periods may be no more than 50% of the total purchases and no less than 30% of the total purchases.

$${\sum }_{i} {\sum }_{k} ( {Inv}_{ijk} ) \leq 0.5 ( {d}_{j} ) ; ∀ j ∈ products , and$$

$${\sum }_{i} {\sum }_{k} ( {Inv}_{ijk} ) \geq 0.3 ( {d}_{j} ) ; ∀ j ∈ products$$

where dⱼ is the demand for product j.
iii. Inventory tracking supplies: The total inventory may be limited by the total supplies. E.g., the total inventory for a particular product that can be stored at a particular node over all time periods may be no more than 50% of the total supply to that node and no less than 30% of the total supply to that node.

$${\sum }_{k} ( {Inv}_{ijk} ) \leq 0.5 ( {\sum }_{m ∈ Pred ( i )} {\sum }_{k} {S}_{mjk} ) ;$$

$$∀ i ∈ nodes and j ∈ products$$

$$and , \\ {\sum }_{k} ( {Inv}_{ijk} ) \geq 0.3 ( {\sum }_{m ∈ Pred ( i )} {\sum }_{k} {S}_{mjk} ) ;$$

$$∀ i ∈ nodes and j ∈ products$$

iv. Inventories tracking each other: One may want to ensure that inventories stored at two different factories are close to each other in amount. One reason why one may want this may be because if a factory fails, the other may be used to satisfy the demand that the failed factory was supposed to satisfy.

Min≦Invₓⱼₖ−Inv_{yjk}≦Max;
∀jεproducts and kεt
where x is the first factory and y is the second factory and the difference in their inventories for a product in a particular time period is bounded.

Similar to above, one can have constraints on demands, supplies, correlations among demands, supplies, inventories etc. In this way sums, differences, and weighted sums of demands, supplies, inventory variables, etc, indexed by commodity, time and location can all be intermixed to create various types of constraints on future behavior. This has been illustrated in the detailed example.

### IV. BRIEF DESCRIPTION OF DRAWINGS

FIG. 1 describes the steps of the sampling approach;

FIG. 2 describes the Scatter plot of min/max cost bounds through demand sampling;

FIG. 3 describes the Information content vs range of output uncertainty;

FIG. 4 describes the Basestock policy for a single inventory variable;

FIG. 5 describes the Basestock policy for 2 inventory variables;

FIG. 6 describes the Basestock policy for 2 inventory variables;

FIG. 7 describes the Generalized basestock policy for 2 inventory variables;

FIG. 8 describes the Linear example of triggering and re-order point polytopes for generalized basestock policy;

FIG. 9 describes the Non-linear example of triggering and re-order point polytopes for generalized basestock policy;

FIG. 10 describes the Example for generalized basestock policy where the triggering and re-order point polytopes are not scaled versions of one another;

FIG. 11 describes the Generating the triggering and re-order point polytopes from a set of nominal points;

FIG. 12 describes the Generating the triggering and re-order point polytopes from demand data

FIG. 13 describes the Single variable control;

FIG. 14 describes the Multiple variable control;

FIG. 15 describes the One variable controlled after the other;

FIG. 16 describes the Different trajectories to bring an operating point into the safe region;

FIG. 17 describes the Hierarchical control using generalized basestock;

FIG. 18 describes the Detailed picture of control at a leaf node; and

FIG. 19 describes the Flexibility in correlated vs. individual control.

### V. OPTIMIZATION ALGORITHMS

The formulation results in tractable models. Firstly, the classical multi-commodity flow model [1] is a natural formulation for supply chain problems. Supply chains can be viewed as networks where there is flow conservation at the nodes. This flow conservation can be written as linear flow equations, under the influence of which any optimization in the supply chain can be solved using network optimization techniques. The fundamental inventory conservation equation is (the subscript t is the time index)

Inventoryₜ₊₁=Inventoryₜ+Supplyₜ−Demandₜ

Let Φ_{S} be the flow vector from the suppliers, Φ_{D} the (variable) demand, and Φ_{I} the inventory. Define Φ as the flow vector [Φ_{S}, Φ_{D}, Φ_{I}], indexed by node, commodity and time. Then the flow conservation equations can be written in the matrix form AΦ≦B, where A is the unimodular flow conservation matrix, and B the source/sink values. All linear metrics are of the form C^{T}Φ. An optimal inventory policy is one which selects the flows to optimize the metric (minimize the cost/maximize the profit). Hence a generic supply chain optimization is of the form

MinC^{T}Φ

AΦ≦B (Equation 1.1)

However, a realistic supply chain is subject to non-convex constraints such as cost/price breakpoints, 0/1 facility location decisions etc and in this case the problem has to be modeled as an ILP with associated computational difficulties. Quadratic terms can also appear in both the constraints and the metric.

When uncertainty is introduced, the right hand side B becomes a variable (and moves to the l.h.s), and additional constraints D^{T}B≦E for these variables are introduced, yielding the LP

$$Min {C}^{T} Φ \\ [ \begin{matrix}A & B\end{matrix} ] [ \begin{matrix}Φ \\ 1\end{matrix} ] \leq 0$$

$${D}^{T} B \leq E$$

Here D^{T}B≦E represents all the (linear) uncertainty constraints described in Section 0.

The optimal policy finds the correct ordering policy (Φ), which minimizes the cost in the worst case of the uncertain parameters. This is a min-max optimization, and is not an LP. Duality can be employed to convert the max to a min, but the presence of non-convexities precludes strong-duality from being achieved [6]. Heuristics have to be used in general. The present invention's approach is statistical. First, the performance is bounded using the absolute minimum and absolute maximum possible costs, corresponding to the best policy under the best conditions and the worst policy under the worst conditions respectively (these can be found directly by max/min the ILP).

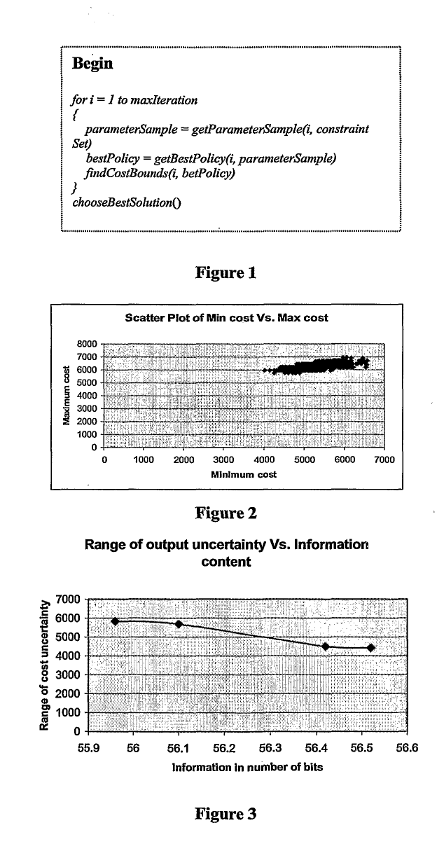

The above bounds serve as input to a statistical policy sampling process illustrated in FIG. 1 of the accompanying drawings, which generates a number of different policies, each of which is optimal for a different randomly chosen demand. The one having the lowest worst-case cost is selected. Determining the worst-case cost for a chosen policy can be shown to be an LP (details omitted). The best policy for a given deterministic demand is given by solving the LP/ILP corresponding to Equation 1.1, for increasingly longer time horizons, and the steady state solution picked. For the example in Section V, for a single time step our LP's had 84 variables (21 integer), and 131 constraints, and the average computation time was just 60 milliseconds.

While the convergence of this process to the Min-max solution is still an open problem, note that the present invention's contribution is the complete framework, and the tightest bound is not necessarily required in an uncertain setting.

### VI. ILLUSTRATIVE EXAMPLE

In this Section, the richness and tractability of the present formulation to handle sophisticated constrained inventory optimizations, typical of realistic applications, which are only approximated using classical methods are illustrated. The classical EOQ methods do not in general incorporate uncertainty, but can be extended to doing so. However, the correlations between different parts of the supply chain are not modellable using this framework. Our methods can very easily handle both, are intuitive, and are also computationally tractable—a unique feature compared to alternative approaches (stochastic, programming, traditional robust optimization)

The present methods reduce to EOQ basestock type solutions [9], in simple unconstrained cases. With constraints, one finds that the optimal policy is not EOQ in general, and EOQ may not even be feasible. Any other work offering these facilities are not known. All of the results were produced on an Intel Celeron 1.60 GHz processor, with a 512 MB RAM.

Consider an example from the automotive sector. Consider a store that deals in cars, tyres, petrol and drivers. There are three kinds of cars and two kinds of tyres, thus there are seven different products that the store provides. This example, while small, is sufficiently illustrative of the capabilities of our approach. To relate our methods to classical EOQ, all the products have a fixed ordering cost and a linear holding cost given in Table 1.

TABLE 1
ORDERING AND HOLDING COSTS OF THE PRODUCTS

| | Ordering Cost in | Holding Cost in |
|---|---|---|
| Product | Rs. (per order) | Rs. (per unit) |
| Car Type I | 1000 | 50 |
| Car Type II | 1000 | 80 |
| Car Type III | 1000 | 10 |
| Tyre Type I | 250 | 0.5 |
| Tyre Type II | 500 (intl shipment) | 0.5 |
| Petrol | 600 | 1 |
| Drivers | 750 | 300 |

Car type I is a comfort class car which has a monthly demand that is on the high side of the scale and there is an average holding cost per car due to the warehouse space occupied. Car type II is a luxury car with much lower demands than the type I car and a holding cost that is larger due to higher protection that it requires and bigger size. Demands are low due to high costs, high maintenance and poor mileage. Car type III is an economy class car, with high demand and considerably lower holding costs due to its small size. Demands are high because of excellent performance, low maintenance, low costs. Tyre type I is a local made tyre, with high demand due to its low prices. Tyre type II is an imported brand, thus the higher ordering cost, and has lower demand due to its higher prices. Both brands have same holding cost, as they occupy same amount of warehouse space. Petrol is ordered from a supplier in another city and stored in an underground storage tank. The store also provides services of professional drivers.

### (a) Exactly Known Demands, No Uncertainty

If the demands for all these products are known exactly then the optimal order quantities and order frequencies can be calculated using the EOQ model [9] as follows:

$${Q}^{*} = \sqrt{\frac{2 CD}{h}} and {f}^{*} = \sqrt{\frac{Dh}{2 C}}$$

where C is the fixed ordering cost per order, h is the per unit holding cost and D is the demand rate.

One sees that the solution given by constrained optimization matches exactly with this solution as given in Table 2.

TABLE 2
EOQ AND CONSTRAINED OPTIMIZATION
SOLUTION FOR KNOWN DEMANDS

| | | | | | Constrained | | |
|---|---|---|---|---|---|---|---|
| | Demand | EOQ Solution | | | Optimization Solution | | |
| | per | Order | Order | | Order | Order | |
| Product | month | Freq | Quant | Cost | Freq | Quant | Cost |
| Car Type I | 40 | 1 | 40 | 2000 | 1 | 40 | 2000 |
| Car Type II | 25 | 1 | 25 | 2000 | 1 | 25 | 2000 |
| Car Type III | 50 | 0.5 | 100 | 1000 | 0.5 | 100 | 1000 |
| Tyre Type I | 250 | 0.5 | 500 | 250 | 0.5 | 500 | 250 |
| Tyre Type II | 125 | 0.25 | 500 | 250 | 0.25 | 500 | 250 |
| Petrol | 300 | 0.5 | 600 | 600 | 0.5 | 600 | 600 |
| Drivers | 5 | 1 | 5 | 1500 | 1 | 5 | 1500 |
| Total | | | | 7600 | | | 7600 |

Car type I, car type II, and drivers must be ordered in every month; car type III, tyre type I and petrol every alternate month; and tyre type II every fourth month.

### (b) Bounded Uncorrelated Uncertainty

Unfortunately, one cannot know the future demands accurately. If one represents this uncertainty as bounds on the individual demands, one can still get min and max bounds from the EOQ model. When the demands are bounded as given by Table 3, the EOQ bounds and bounds from the constrained optimization solution are also almost the same as shown in Table 4. The only difference is in the ordering of “tyre type I” and “drivers” as the EOQ solution specifies an optimal order quantity of 248.99 tyres/order and 2.24 drivers/order which is clearly not realizable, so the constrained optimization rounds this to 248 tyres/order and 2 drivers/order.

For this kind of uncertainty, one needs to order car type I, car type II, and drivers at least every alternate month and at most every month; tyre type I, tyre type II and petrol at least every fourth month and at most every alternate month; and car type II at least never and at most every month.

TABLE 3
UPPER AND LOWER BOUND ON DEMANDS

| Product | Min Demand | Max Demand |
|---|---|---|
| Car Type I | 10 | 40 |
| Car Type II | 0 | 25 |
| Car Type III | 50 | 200 |
| Tyre Type I | 62 | 250 |
| Tyre Type II | 125 | 500 |
| Petrol | 75 | 300 |
| Drivers | 1 | 5 |

TABLE 4
EOQ AND CONSTRAINED OPTIMIZATION
SOLUTION FOR BOUNDED DEMANDS

| | EOQ solution | | | | Constrained Optimization | | | |
|---|---|---|---|---|---|---|---|---|
| | Order | | Order | | Order | | Order | |
| | Frequency | | Quantity | | Frequency | | Quantity | |
| Product | Min | Max | Min | Max | Min | Max | Min | Max |
| Car Type I | 0.5 | 1 | 20 | 40 | 0.5 | 1 | 20 | 40 |
| Car Type II | 0 | 1 | 0 | 25 | 0 | 1 | 0 | 25 |
| Car Type III | 0.5 | 1 | 100 | 200 | 0.5 | 1 | 100 | 200 |
| Tyre Type I | 0.25 | 0.5 | 248.99 | 500 | 0.25 | 0.5 | 248 | 500 |
| Tyre Type II | 0.25 | 0.5 | 500 | 1000 | 0.25 | 0.5 | 500 | 1000 |
| Petrol | 0.25 | 0.5 | 300 | 600 | 0.25 | 0.5 | 300 | 600 |
| Drivers | 0.45 | 1 | 2.24 | 5 | 0.5 | 1 | 2 | 5 |

### (c) Beyond EOQ: Correlated Uncertainty in Demand

So far, the constrained optimization model has incorporated the simple mechanics of the EOQ model perfectly. Now it will be shown as to how the model can be used to incorporate more complicated behavior, which EOQ cannot represent. Compared to general constrained optimization approaches (e.g. SAP APO) used in supply chain optimizers, one shall see that the present approach is based on very intuitive information, which is conveniently available to planners.

Considering that the three types of cars are substitutive and the two types of tyres are also substitutive, this can be represented by the following equations:

200≦dem_tyre_{—}1+dem_tyre_{—}2≦700

65≦dem_car_{—}1+dem_car_{—}2+dem_car_{—}3≦250

The first inequality means that if the demand for one type of tyre increases, the demand for the other type of tyre should go down and vice versa. This constraint takes into account the fact that the demands for the two brands of tyres are correlated and coexist. The lower bound here is greater than the sum of lower bounds on demands of individual types and the upper bound is smaller than the sum of upper bounds on individual demands, thus creating the substitutive effect.

Similarly the second inequality means that the demand for all types of cars cannot increase or decrease simultaneously. Here also one has substitutive effect as the lower bound on the sum is greater that sum of lower bounds on demands of individual types and the upper bound on the sum is smaller than the sum of upper bounds on individual demands.

Complementary effect between different products can also be easily expressed as bounds on differences, for example, consider the following inequality:

5≦(dem_car_{—}1+dem_car_{—}2+dem_car_{—}3)−dem_petrol≦20

This constraint represents the assumption that the demand of petrol tracks the demand of cars. If there is an increase in the demand for cars, the demand for petrol will simultaneously rise and vice versa.

Let us suppose that people who buy luxury cars (car type II) are more likely to hire drivers too and the drivers provided by the store are almost always for luxury car owners. Then the demand for drivers must track the demand for luxury cars and this is represented by the following constraint:

5≦dem_car_{—}2−dem_drivers≦20

The results for optimization in the best case for different scenario sets are shown in Table 5. The solution in each of these cases is very different from the EOQ solution and demonstrates the capability of the present formulation to easily incorporate complicated co-relations amongst different parameters.

TABLE 5
BEST CASE SOLUTIONS FOR DIFFERENT SCENARIO SETS

| | With | | With | | With both Substitutive | |
|---|---|---|---|---|---|---|
| | Substitutive | | Complementary | | and Complementary | |
| | Constraints | | Constraints | | constraints | |
| | Order | Order | Order | Order | Order | Order |
| Products | Freq | Quant | Freq | Quant | Freq | Quant |
| Car Type I | 0.5 | 20 | 0.5 | 20 | 0.5 | 20 |
| Car Type II | 0 | 0 | 0.5 | 12 | 0.5 | 12 |
| Car Type III | 0.5 | 110 | 0.5 | 128 | 0.5 | 128 |
| Tyre Type I | 0.25 | 274 | 0.25 | 248 | 0.25 | 261 |
| Tyre Type II | 0.25 | 526 | 0.25 | 552 | 0.25 | 539 |
| Petrol | 0.25 | 300 | 0.25 | 300 | 0.25 | 300 |
| Drivers | 0.5 | 2 | 0.5 | 2 | 0.5 | 2 |

Comparing the solution in Table 5, when both substitutive and complementary constraints are valid with the EOQ solution of Table 4, we see that the EOQ solution is not even valid for this case. The lower bound on the cost by the EOQ solution is Rs. 3348.248, whereas in the substitutive-complementary constrained case the lower bound on the cost is Rs. 4482.5. With just substitutive constraints car type II need not be ordered at all, but when complementary constraints are considered it must be ordered at least every alternate month.

### (d) Correlated Inventory Constraints

Let us now consider that the inventory holding capacities are constrained. Let us suppose that the store in the example has a warehouse where it stores cars and tyres. Taking the scenario set when all the constraints are acting the total inventory of cars will begin with 120 cars and the inventory of tyres with 700 tyres. Now since we have limited storing capacity, let us suppose that we cannot store more than 160 tyres at any given time and no more than 68 cars. These limitations can be represented by the following constraints:

Inv_tyre_{—}1+Inv_tyre_{—}2≦120

Inv_car_{—}1+Inv_car_{—}2+Inv_car_{—}3≦68

Since we cannot store more inventories now, we will have to reduce our order quantities. In order to fulfill the demand, now we will have to place more frequent orders than before. This is exactly what the solution from our formulation gives us and is given in Table 6.

TABLE 6
BEST CASE SOLUTION WHEN INVENTORIES
ARE CONSTRAINED

| Product | Order Frequency | Order Quantity |
|---|---|---|
| Car Type I | 0.5 | 20 |
| Car Type II | 0.25 | 24 |
| Car Type III | 1 | 64 |
| Tyre Type I | 0.5 | 124 |
| Tyre Type II | 1 | 138 |
| Petrol | 0.25 | 300 |
| Drivers | 0.5 | 2 |

The total cost for this policy is Rs. 5195.5, Rs. 713 greater than when there are no inventory constraints.

### (e) Computational Procedure

As stated in Section V, the min-max inventory policy (best decisions for the worst case demands, inventories) for the case when only bounds and substitutive are acting is found by taking 1500 inventory policy samples shown by the scatter plot in FIG. 2. On the x-axis is the minimum cost for the sample, on the y-axis the maximum cost for the sample. The lower bound on cost (Min-Min solution) is Rs. 3412.5, and the upper bound is Rs. 9100. From this scatter plot, the Min-Max solution has a cost not exceeding Rs. 5775, which is about 70% higher than the (unrealistic) min-min bound. The important point to note is that these are global bounds, and are valid over the entire (infinite) range of parameter (demand, supply, . . . ) variations, including inventory constraints. Most alternative approaches either take deterministic demands or a few scenarios (low/average/high). The stochastic programming framework typically makes uncorrelated assumptions about probability distributions. The traditional robust programming approach does not have the rich correlated behavior that the present invention can handle.

While we have described a simple example, we have successfully run examples with up to 500 products, multiple locations, and tens of time steps. With improvements in our computational methods, we expect to be able to handle industrial scale problems. Table 7 summarizes statistics for some of the examples that we have run and have obtained optimal solution, the largest having 78000 variables (18000 integer) and 126000 constraints.

TABLE 7
DETAILS OF DIFFERENT PROBLEMS SOLVED
USING THE NEW FORMULATION

| Locations | Products | Time steps |
|---|---|---|
| 1 | 1 | 100 |
| 1 | 1 | 200 |
| 1 | 25 | 24 |
| 15 | 7 | 12 |
| 60 | 2 | 12 |
| 16 | 10 | 6 |
| 1 | 500 | 12 |
| 100 | 1 | 12 |

The present formulation offers additional capabilities. Using techniques described in [12], one can estimate the amount of information in each one of the scenarios, by estimating the volume of the polyhedron [10] enclosed by the constraints composing the scenario. Table 8 summarizes the bounds on output cost and the amount of information encompassed by the constraints in each of the scenario sets. As more and more constraints are added, very less information is being to the system, as the information content is increased by less than 1 bit of information, but there is considerable change in the bounds. The absolute amount of information (around 55 bits) is based on a normalization volume—this reflects the apriori knowledge in the absence of any constraint information.

TABLE 8
RELATIVE INFORMATION CONTENT
OF DIFFERENT SCENARIO SETS

| | Absolute | Absolute | Information |
|---|---|---|---|
| | Minimum | Maximum | Content |
| Scenario sets | Cost | Cost | (Number of bits) |
| Bounds only | 3349.5 | 9187.5 | 55.96 |
| Bounds and Substitutive | 3412.5 | 9100 | 56.10 |
| constraints | | | |
| Bounds and Complementary | 4469.5 | 8972.5 | 56.42 |
| constraints | | | |
| Bounds, Substitutive and | 4482.5 | 8910 | 56.52 |
| Complementary constraints | | | |

As more and more constraints are added, the uncertainty in the input data reduces. It is expected that the uncertainty in the output should also reduce simultaneously. Indeed this is true. When the substitutive and complementary effects are not considered, then the total minimum investment required is Rs. 3349.5. In this particular example, the substitutive effects do not affect the cost very much, but as soon as one considers the complementary effects between different products, the lower bound on cost shoots up to Rs. 4469.5, while the upper bound goes down from Rs. 9187.5 to Rs. 8972.5. When one considers both the substitutive and complementary effects, the lower bound further increases while the upper bound reduces to Rs. 8910.

As one increases the information about the input data, reducing the number of possibilities, the possible range of the output data also reduces. The graph in FIG. 3 shows how the range of output varies with the information content for all the different scenarios. X-axis represents information content in number of bits for a scenario and y-axis shows the range of output uncertainty (the difference between the absolute maximum cost and the absolute minimum cost).

One can also analyze the relationship between scenarios using the relational algebra of polytopes.

### VII. INVENTORY OPTIMIZATION USING GENERALIZED BASE STOCK

Classical inventory control does not account for correlations between inventories of different product optimizations are done independently. Our approach naturally incorporates correlations, and results in generalizations of the well-known basestock policies, discussed below. In our discussion below the words “operating point” refer to a state of the supply chain system, with specific values for the demand, supply, inventory, flow and other variables at each node/edge, for each product, for each instant of time.

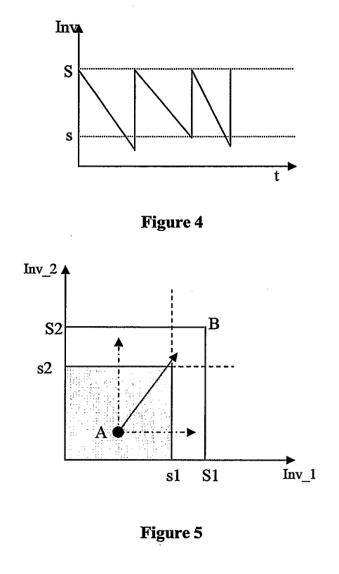

An example of classical basestock is shown in FIG. 4, for a supply chain with a single product. Basically, if the inventory dips below the level “s”, then re-orders bring it up to “S”.

If the classical basestock is applied to a 2-product situation (FIG. 5), the situation is as follows (there are 2 inventory variables). For the first inventory variable (Inv_1), the (s,S) thresholds are (s1, S1) and for the second inventory variable (Inv_2) they are (s2, S2). If Inv_1 falls below s1, then a reordering is triggered and Inv_1 is replenished to reach the S1 level. Similarly for Inv_2. In this case, if both Inv_1 and Inv_2 fall below their respective's′ thresholds, say to point ‘A’, then there is only one direction to take to reach point ‘B’, or only one optimal ‘trajectory’ to follow reach from point ‘A’ to ‘B’, since the inventory variables are independent of one another so they will both be controlled at the same time at once.

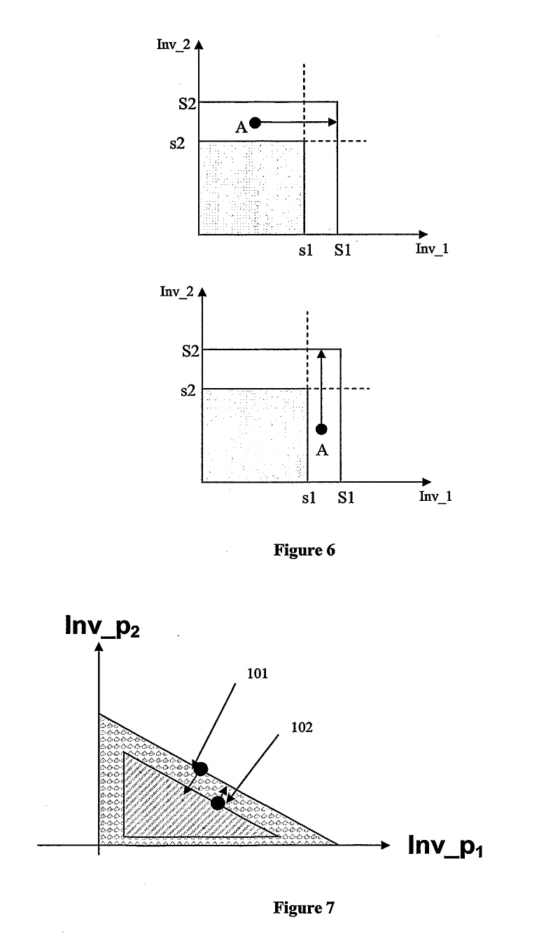

If only one of Inv_1 and Inv_2 fall below the ‘s’ threshold, then also there is one trajectory (path) to take to replenish the scanty inventory to ‘S’ level. (FIG. 6)

However, in general, there are correlations between different product inventories, as described in Section III, and generalizations of basestock policies can offer significant benefits, as compared with independently controlling inventories of each product. We discuss this below:

### Generalized Basestock w.r.t Inventory Variables.

A 2-D example of a correlated constraint between inventory of product 1 and product 2 is:

Inv_{—}p1+Inv_{—}p2<=1000,
Inv_p1>=0; Inv_p2>=0; We assume no backorders

A generalized basestock-style inventory policy using this constraint can be defined as follows. First, the set of constraints defines a polytope. From this polytope, we generate two polytopes, an inner polytope which represents the point at which inventory of one or more goods has fallen too much, and an outer polytope, which represents the amount to which inventory has to be replenished. The inner and outer polytopes correspond to the thresholds's′ and ‘S’, respectively of an (s,S) basestock policy, but instead of thresholds; we have inner and outer polytopes. The policy is as shown in FIG. 7, and described further below.
If the operating point is inside the outer polytope 101 (this should always be the case), but outside the inner polytope 102 (inventory has not fallen too much): no order
Else (operating point inside inner polytope), order the minimum necessary (plus margin to prevent immediate violations) to move the operating point to the closest point on the outer polytope (or other suitable point).

This generalizes basestock policies, which are based on single goods. The constraint region can be an arbitrary polytope, and may have many faces. The basic difference from a standard (s,S) policy is that the thresholds and reorder point of each product, keep changing, as a function of available inventory of the other products. In the figure above, if there is a lot of inventory of p2, very little of p1 is ordered, since it is known that within limits, p2 can be used instead of p1 (a substitution effect). Conversely, with little inventory of p2, the supply chain ensures that there is a lot of p1 available, by reordering large quantities

In general, if the polytope is based on demand/supply/inventory/price/ . . . variables, the same policy can be generalized to specify a triggering polytope 102, at whose boundary re-order (or other supply chain event) is triggered, and a reorder point polytope 101, to which the operating point of the chain is moved. An optimal point on the reorder point boundary is chosen to optimize some metric, e.g. cost, total inventory, profit, etc. The policy is not restricted to polytopes specified linear constraints, but also general convex bodies specified by constraints. A few variants of the trigger and re-order polytopes are described below. Typically, but not exclusively, the trigger and re-order polytopes are based on constraints on inventories.

### Generation of the Triggering and the Re-Order Point Polytopes:

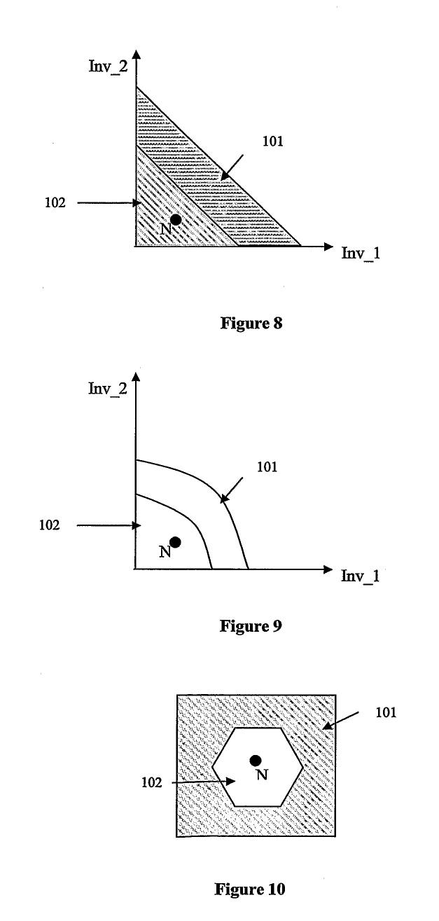

1) The trigger polytope 102 can be generated by taking a nominal operating point ‘N’ and creating a simple triangular polytope around it, which could server as the inner trigger polytope. This trigger polytope can then be scaled up to form an outer re-order polytope 101. (FIG. 8 and FIG. 9)
2) The trigger 102 and re-order 101 polytopes need not be scaled versions of each other. An example is shown in FIG. 10.

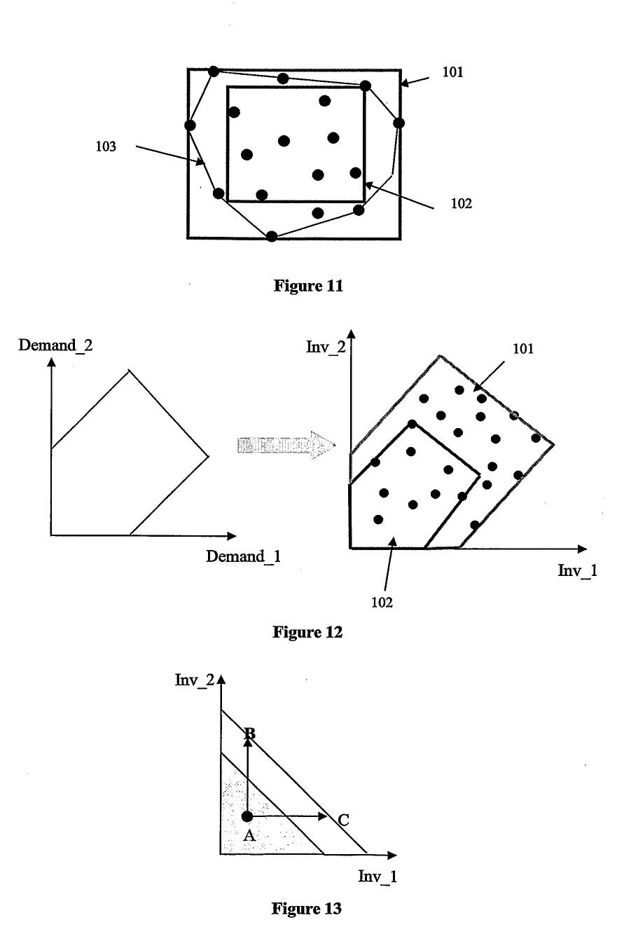

The trigger and re-order point polytopes can be formed from several nominal operating points (FIG. 11), obtained exemplarily through actual observations. The convex hull 103 or an approximation to the convex hull is drawn around the set of nominal points. An inscribed polytope 102 within this hull can serve as the triggering polytope and a circumscribed polytope 101 can serve as the re-order point polytope.

Other methods are also possible to estimate the trigger and re-order polytopes. If the SKUs are being independently controlled, then we will know their individual (s,S) thresholds and also historical inventory levels. Along with this information, historical demand data is also available to us. Using this demand data, relationships between demands for different products can be inferred using linear/non-linear programming techniques, as described in our earlier applications (PCT/IN2009/000390, PCT/IN2009/000398). From these demand relationships and the historical inventory data, the inner triggering and the outer re-order point polytopes can be derived. This is depicted in FIG. 12. Trigger 102 and re-order 101 polytopes are fitted around the historical inventory data based on the relationships between the demands for the two products. While the shape of the trigger and reorder polytopes is shown as being the same as the demand constraint region, this need not be the case in general.

Since there are many possible triggering and re-order point polytopes, the question that arises is that how many constraints should we derive? One answer is to choose them such that the volume of the convex polytope formed by these constraints is close to the minimal volume possible—that of the convex hull. Other methods are also possible. Using the constraints comprising the convex hull directly may not be meaningful in some application contexts, since it may result in constraints which are neither substitutes nor complements, etc. Additionally, the convex hull typically has a very large number of faces, most of which do not have any direct economic meaning. In such cases, a smoothed version of the convex hull, where many facets are merged to each other can be used.

The trigger polytope can be chosen to be suitable for monitoring (e.g. composed of constraints on observable variables only), and the re-order polytope can be that suitable for ordering (e.g. composed of constraints on those combinations of goods for which ordering cost is small for each good in the combination). The point to which a re-order moves the operating point of the system, be based on some economic criterion, and maybe to minimize cost, maximize profit, easy implementation, etc.

Once we have one generalized base-stock policy, i.e., one set of triggering and re-order point polytopes, we can apply transformations to these polytopes to generate new policies. We can apply translations, rotations or other distortions that keep the volume unchanged. By keeping the volume fixed, we are generating information equivalent policies from a given policy. It is also clear that these same transformations can be generalized to increasing the volume and decreasing the information content, and vice versa. Using these transformations, we can populate a database of policies.

### Optimal Trajectory Control in a Generalized Basestock Framework.

Even after deriving a trigger and a re-order polytope, there are multiple choices in deciding trajectories to move between the two (this is a feature not present in the classical single variable basestock policy). We discuss this further below

### Generalized Basestock Control Trajectories:

If at any time in the operation of the supply chain, the operating point goes inside the trigger polytope, a variety of actions can be undertaken to reset inventories of different products to safe levels. These different actions result in different trajectories to take from the initial (non-safe) state to the final state. A couple of generic examples of these trajectories are detailed below (these differ in the number of variables being simultaneously changed):

### Single Variable Control—

We can control one variable, so from the trigger point ‘A’, we can either go to ‘B’ by increasing Inv_2 or we can go to ‘C’ by increasing Inv_1. (FIG. 13)

### Multiple Variable Control—

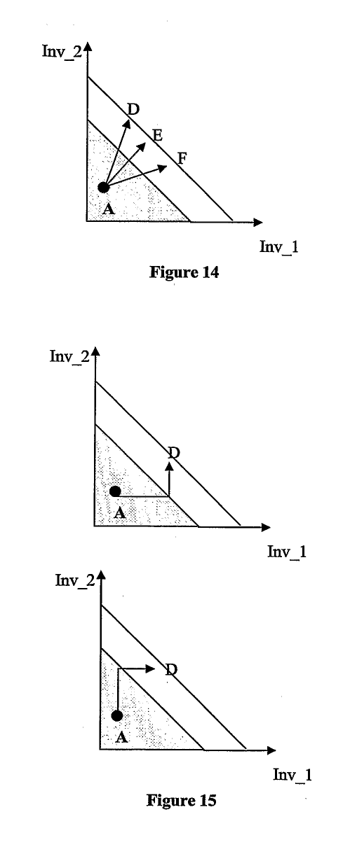

We can control multiple variables together. In this case, we can increase inventories for multiple items at the same time while following the substitutive relationship between them. So we can follow any path as long as the resultant point lies in the outer re-order point polytope. In the example in FIG. 14, we go to either ‘D’, or ‘E’ or ‘F’ based on some economic criteria or ease of implementation etc.

### Sequential Control—

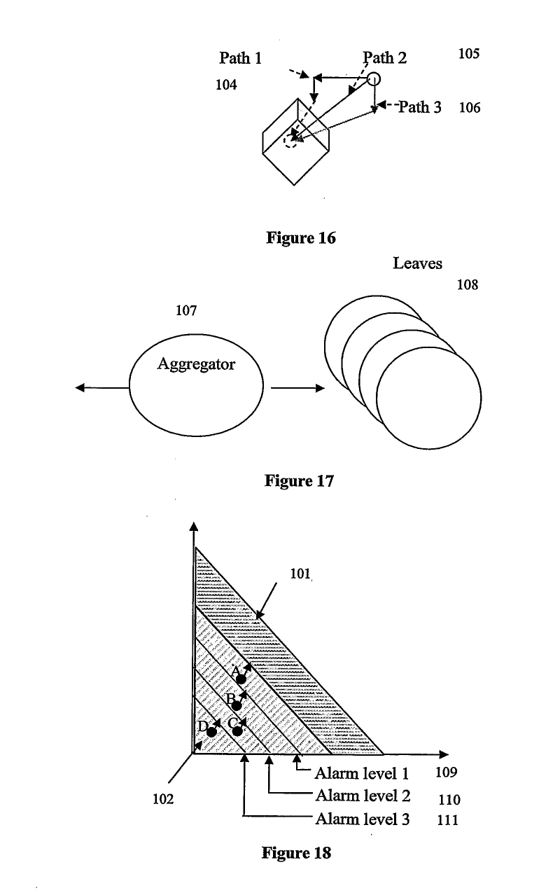

We can control one variable after the other. In the examples in FIG. 15, first one inventory is replenished and followed by the other. Two different paths are shown to reach from the trigger point ‘A’ to the re-order point ‘D’. FIG. 16 shows a number of other paths 104,105 and 106 that can be taken to take the operating point into the safe region.

While we have described the invention with a single trigger and a single re-order polytope, multiple trigger/re-order polytopes can be used, with different actions being triggered as different triggering polytopes are reached by the operating point. These polytopes need not be on the same variables. A collection of such trigger/re-order polytopes forms a sense/response system in a supply chain. A software architecture exemplarily graphically displaying the status relative to trigger/reorder polytopes can be used to monitor/control this sense-response system. With many kinds of products, the dimensionality of the polytopes requires special visualization methods like projections onto lower dimensional spaces, multidimensional scaling, etc. The distance between these polytopes can be calculated, and assessed, to ensure an adequate margin between them. As compared to an inventory policy using mathematical optimization from scratch, generalized basestock is a simple and intuitive inventory policy, and easily understood and implemented.

Generalized Basestock Variants: Hierarchical Triggering from Leaves with Sensor Data Through Alarms at Various Levels (Constraints at Various Levels).

Generalized basestock can be applied hierarchically, with multiple trigger and re-order polytopes at different levels. A lower level trigger can initiate an action, which is monitored by the higher level for being inside the higher level trigger region. For example, several subsets of the supply chain may serve as leaves 108 in the system. The leaves employ generalized base-stock to do local correction for the operating point as well as to raise a series of alarms. Alarms from different leaves 108 are aggregated 107 at a higher level and different constraints can be defined based on this. Constraints could define one action or another to be taken depending on the aggregate alarm levels. (FIG. 17)

FIG. 18 shows an example of hierarchical control, where a supply chain depicting retail inventories at the leaves, and monitored/controlled at the next level of hierarchy, from a warehouse is depicted. If the operating point falls into the triggering polytope but it is outside the ‘alarm level 1’ 109 envelope (point A), then a re-ordering is made to move the operating point into the outer polytope but no alarm is raised. If the operating point falls below the ‘alarm level 1’ 109 line but above the ‘alarm level 2’ 110 line (point B), then a re-order is made and the first alarm is raised. If the operating point falls below the ‘alarm level 2’ 110 line but above the ‘alarm level 3’ 111 line (point C), then a re-order is made and the second alarm is raised. If the operating point falls below the ‘alarm level 3’ 111 line (point D), then a re-order is made and the third alarm is raised.

The raised alarms are sent to the next higher level. At the next level, the alarms are aggregated and an action is taken according to some constraints such as the following. If the total alarm level from all the nodes exceeds a quantity, then an alarm is raised to the next level. The aggregator can also decide between taking a local corrective action vs. a non-local action. If an alarm is raised by one leaf node and other leaf nodes are operating in their safe regions, then the aggregator may decide to replenish the inventory of the leaf that raised an alarm from the inventories of other nodes. In this way, the aggregator may perform a balancing action. If the total inventory levels across all the leaves fall below a threshold, then a re-order to an external supplier may be placed, and higher level authorities in the supply chain notified.

### Greater Flexibility in Correlated Control

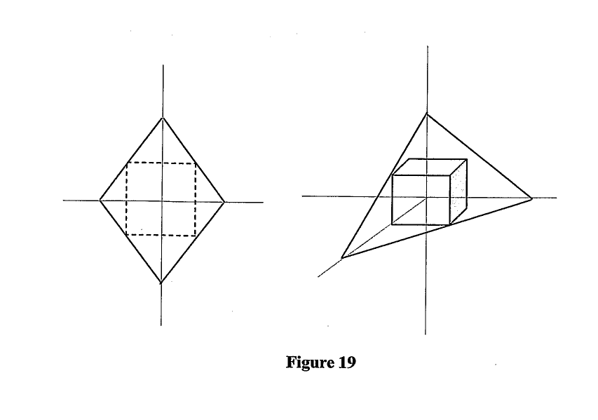

The ability to control aggregates instead of individual stock SKUs (stock keeping units) gives a greater flexibility of control too. In the presence of substitutive constraints, the feasible region will be a triangle in 2 dimensions and a tetrahedron in 3 dimensions. The largest area that the variables are allowed to independently vary within this feasible region will be the inscribed square and the inscribed cube respectively. (FIG. 19) However, both of these cutoff large portions of the feasible region (the region near the vertices). The ratio of the volume of the outer feasible region to that of the inscribed region within which the parameters are allowed to independently vary increases exponentially as the number of dimensions increases. Thus, correlated constraints allow a greater region of feasibility, providing greater flexibility of control.

### Application of Basestock to Other Contexts:

Monitoring of the Operating Point with Respect to the Constraints (Real Time Control)

The ideas of a trigger and a re-order polytope can be utilized in many places, not just inventory re-ordering. Essentially the trigger polytope is a set of constraints, which, when satisfied by the operating point, trigger an appropriate response, to get the system back to a “safe-state.

For example, the generalised base-stock can be used for searching for new suppliers, warehouses, markets etc. The availability of supplies with suppliers can be constrained. If the total availability falls into the triggering polytope, a new supplier search can be triggered.

Similarly, the total available capacity in the warehouses may be constrained by the inner and outer polytopes of generalised base-stock. If the total available capacity falls into the triggering polytope, a new warehouse search can be triggered. For a new market search, the total demand can be constrained and monitored.

We stress that all our techniques can be implemented in a software module (using exemplarily SOA/SAAS technologies), and/or in hardware.

### VIII. CONCLUSION

The present approach offers a convenient and intuitive specification to handle uncertainty in supply chains. Most other formulations handling uncertainty make ad-hoc assumptions about demand variations, independence between different goods, etc. Our approach does away with these in a simple and elegant fashion, using intuitive information meaningful in economic terms, while retaining computational tractability. It has shown considerable promise by being able to solve problems with realistic costs with many breakpoints and simultaneous complicated constraints. The approach naturally leads to a generalization of basestock policies to multidimensional correlated variables. The generalized basestock policies can be used in many contexts. It has successfully analyzed semi-industrial scale problems. The present invention extends the state-of-art in a theoretically and practically useful direction.

### IX. REFERENCES

[1]. Ahuja, Magnanti, Orlin: Network Flows, Theory, Algorithms and Applications, Prentice Hall, 1993.
[2]. Arrow, K., Harris, T., Marschak, J. (1951): Optimal inventory policy, Econometrica, 19, 3, pp. 250-272
[3]. Bertsekas, D., Dynamic programming and optimal control, Volume 1, Athena Scientific, 2005
[4]. Bertsimas, D., Thiele, A.: Robust and Data-Driven Optimization: Modern Decision-Making Under Uncertainty, Optimization Online, Entry accepted May 2006
[5]. Bertsimas, D., Sim, M. (2004): The price of robustness, Operations Research, 52, 1, pp. 35-53
[6]. Boyd, S., Vandenberghe, L.: Convex Optimization, Cambridge University Press 2007
[7]. Clark, A., Scarf H. (1960): Optimal Policies for a Multi-Echelon Inventory Problem, Management Science, 6, 4, pp. 475-490
[8]. Dvoretzky, A., Kiefer, J., Wolfowitz, J. (1952): The inventory problem, Econometrica, pp. 187-222
[9]. Harris, F., (1913): How many parts to make at once, Factory, The magazine of management
[10]. László Lovász and Santosh Vempala—Simulated annealing in convex bodies and an O*(n4) volume algorithm, Journal of Computer and System Sciences, Volume 72, Issue 2, March 2006.
[11]. Prasanna, G. N. S.—Traffic Constraints instead of Traffic Matrices: A New Approach to Traffic Characterization, Proceedings ITC, 2003.
[12]. Prasanna, G. N. S., Aswal, A., Chandrababu, A., Paturu, D.—Capacity Planning under Uncertainty: A Merger of Robust Optimization and Information Theory applied to Supply Chain Management, Proceedings ORSI Annual Convention, December 2007.
[13]. Whitin, T. M., (1952): Inventory Control in Theory and Practice, The Quarterly Journal of Economics, 66, 4, pp. 502-521
[14]. Shapiro, et al: A Tutorial on Stochastic Programming at www.stocprog.org
[15]. Bertsimas, D., Thiele, A.: Robust and Data-Driven Optimization: Modern Decision-Making Under Uncertainty, Optimization Online, Entry accepted May 2006
[16]. Bertsimas, D., Sim, M. (2004): The price of robustness, Operations Research, 52, 1, pp. 35-53
[17]. Prasanna, G. N. S., Aswal, A., Chandrababu, A., Paturu, D.13 Capacity Planning under Uncertainty: A Merger of Robust Optimization and Information Theory applied to Supply Chain Management, Proceedings ORSI Annual Convention, December 2007.

### Annexure

Coupling Information Theory with Optimization: a New Approach to Robust Design of Supply Chains

Point specifications of parameter vectors (demand, supply, . . . ) in deterministic supply chain models do not explore the vast majority of parameter space, and the designs are not robust. Conventional practice in robust supply chain design/optimization uses a few best/average/worst case scenarios. Recent approaches using stochastic programming [14] rely on hard-to-estimate probability distributions. The constraints used in robust programming [15, 16] approaches are generally domain independent, and typically restricted to parameters confined to ellipsoids or symmetric polyhedra around a nominal point. In addition, there is little information about the nature of the constraints—viz their information content, their relation to market behaviour, etc.

Robust designs require us to consider design/optimizations over large ensembles of parameter vectors. The simplest ensemble, a hypercube of [min,max] bounds for each parameter, does not capture most interesting correlations between parameters, and the same is true of ellipsoidal uncertainty used in most SOCP's. Our formulation [16, based on general linear (and quadratic) constraints amongst the parameters, is able to offer these unique capabilities:
Capture the imprecise input data in the form of constraints representing economically meaningful behaviour. This yields a polytope, whose faces represent economically meaningful behaviour—substitutive, complementary and general revenue/profit constraints, in addition to bounds.

For example, a substitutive constraint between demand for product 1, d1 and d2 is of the form

Min<=d1+d2<=Max

A complementary constraint is of the form

Min<=d1−d2<=Max, etc
Quantify the amount of information present in the ensemble, based on an equivalence of polyhedral volume to information content. The volume of the polyhedron formed by the above constraints measures the number of scenarios considered and the information content.
Compare different sets of imprecise input data based on the relational algebra of polytopes. We are able to determine if one input data set is different from, the same as, or a subset of another.
Create computationally efficient algorithms to obtain tight bounds on many objectives of interest.
Relate the information content/uncertainty in the output parameters, to that in the input parameters, based on an equivalence of polyhedral volume to information content.

1. A computer implemented method for carrying out inventory optimization under uncertainty comprising the step of feeding information in the form of polyhedral formulation of uncertainty where the faces and edges of the polytope are built from linear constraints that are derivable from historical time series data.

2. A computer implemented method for carrying out inventory optimization using generalized base-stock policy, which offers correlated control for more than one inventory variables and involves a reorder polytope and trigger polytope.

3. A computer implemented method as claimed in claim 1, wherein the inventories are replenished to the level of the re-order polytope whenever the inventory values lie within the trigger polytope.

4. The method of claim 3 where said trigger and re-order polytopes are over inventory variables.

5. The method of claim 3 where said trigger and re-order polytopes are scaled or translated versions of one another.

6. The method of claim 3 where said trigger and re-order polytopes differ in shape.

7. The method of claim 3 where more than one of said trigger or said re-order polytopes is used.

8. The method of claim 3, where there are two or more said trigger polytopes, with one a subset of another, and when the set of inventory variables moves to a first trigger polytope, a first action is taken by inventory policy, and when the set of inventory variables moves to a second trigger polytope, a second action is undertaken by the inventory policy.

9. The method of claim 3, where at least two trigger and re-order polytopes are used, with a second parameter for the said second trigger polytope, being changed by inclusion of inventory parameters for the first trigger polytope, inside the said first trigger polytope, the first and second polytopes thus comprising a hierarchy of polytopes, with the said first trigger polytope being at a different level of hierarchy compared to the said second trigger polytope.

10. The method of claim 3, where the operating point in the re-order polytope is the closest in the re-order polytope, to the point in the trigger polytope.

11. The method of claim 10, where the operating point in the re-order polytope is reached from the operating point in the trigger polytope, in more than one supply chain reorder action.

12. The method of claim 11, where the supply chain reorder action orders only one good at a time.

13. The method of claim 11, where the supply chain reorder action orders more than one good at a time.

14. The method of claim 3, where the trigger and re-order polytopes are estimated based on the constraints satisfied by the demand of the product corresponding to each inventory variable comprising said trigger and re-order polytopes.

15. A computer system for carrying out inventory optimization under uncertainty comprising means for feeding information in the form of polyhedral formulation of uncertainty where the faces and edges of the polytope are built from linear constraints that are derivable from historical time series data.

16. A computer system as claimed in claim 15 for carrying out inventory optimization using generalized base-stock policy, which offers means for controlling more than one correlated inventory variable involving a reorder polytope and trigger polytope.

17. A computer system as claimed in claim 15, wherein the inventories are replenished to the level of the re-order polytope whenever the inventory values lie within the trigger polytope.

18. The system of claim 15 where said facilities are implemented as a software service using SOA or SAAS methodologies, as a plug-in to existing supply chain management software.

19. The system of claim 15 where said facilities are implemented as a hardware application specific integrated circuit.

20. The system of claim 19, where said facilities are implemented using high speed linear and/or convex programming solvers implemented in hardware.
